(19) United States
(12) Patent Application Publication
(10) Pub. No.: US 2010/0088143 A1
(43) Pub. Date: Apr. 8, 2010

(54) CALENDAR EVENT SCHEDULING

(75) Inventors: John C. Platt, Redmond, WA (US); Jonathan J. Cadiz, Redmond, WA (US); Joseph L. Hellerstein, Seattle, WA (US); Brian D. Williams, Redmond, WA (US); Sumit Basu, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/246,505

(22) Filed: Oct. 7, 2008

(51) Int. Cl. G06Q 90/00

(52) U.S. Cl. 705/9

(57) ABSTRACT

The described implementations relate to calendar event scheduling. One system includes a storage component configured to store scheduling constraints relating to at least one user. The system also includes a declarative calendar component configured to automatically schedule declarative calendar events for the at least one user based upon the scheduling constraints.

### BACKGROUND

Many computer users have adopted electronic calendar applications during the last couple of decades. Even with these electronic calendar applications, most calendar events are scheduled in a manual and time consuming manner. For instance, if a user wants to schedule a meeting with two colleagues, he/she tries to find a suitable date and time for the three participants. The user often sends an email to the colleagues asking if a selected time will work. The colleagues have to review their own calendars and respond to the user. Often several rounds of emails are exchanged before the date and time are agreed upon. The user may also have to find a suitable location, such as an available conference room. Further, if one of the attendees has to cancel the meeting for some reason, the process has to be started anew. The present inventive concepts offer an alternative paradigm for calendar event scheduling that can offer significant time and/or convenience factors to the participants.

### SUMMARY

The described implementations relate to calendar event scheduling. One system includes a storage component configured to store scheduling constraints relating to at least one user. The system also includes a declarative calendar/calendaring component configured to automatically schedule declarative calendar events for the at least one user based upon the scheduling constraints.

Another implementation is manifested as a technique that presents a declaratively scheduled calendar event to a proposed attendee. The technique also allows the proposed attendee to either accept the declaratively scheduled calendar event or specify constraints that cause rescheduling of the declaratively scheduled calendar event. The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIG. 1 shows a declarative calendar event scheduling system or technique in accordance with some implementations of the present concepts.

FIGS. 2-8 show hypothetical screenshots of exemplary declarative calendar event scheduling user interfaces in accordance with some implementations of the present concepts.

FIG. 9 illustrates an exemplary declarative calendar event scheduling operating environment or system in accordance with some implementations of the present concepts.

FIGS. 10-12 are flowcharts of exemplary declarative calendar event scheduling techniques in accordance with some implementations of the present concepts.

### DETAILED DESCRIPTION

### Overview

This patent application pertains to declarative scheduling of calendar events. A calendar event can be a date and time that are reserved, or can be reserved, for one or more users for a given reason(s). A calendar event may exist in a singular instance, multiple parts, and/or be recurring. Traditionally, a user manually or explicitly schedules calendar events by trying to find a time that is clear on his/her calendar and is also clear on the calendar of other desired attendees. This may take a considerable amount of time and communications between the user and the attendees that can basically be considered as lost or unproductive time. In contrast, among other attributes, the present concepts can offer a substantial time saving advantage to the user.

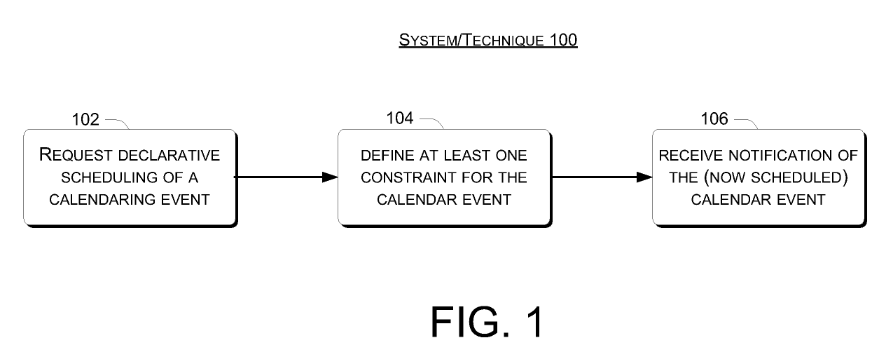

FIG. 1 relates to a system or technique 100 that introduces the reader to the present concepts from the perspective of a user. The user can request declarative scheduling of a calendar event at 102. For instance, the user may view an interface for a calendar application and select a declarative scheduling feature from the interface. The user can define at least one constraint for the calendar event at 104. For example, the user may select attendees for the calendar event, that a conference room is needed, and that the calendar event has to occur by the end of the following week. The user receives notification of the (now scheduled) calendar event at 106. For instance, the user may receive a dialog box that the calendar event has been scheduled along with the date and time. In another case, the calendar event may simply be added to the user's calendar. Accordingly, the user is freed from many of the time consuming aspects of traditional manual calendaring.

### Exemplary Screenshots

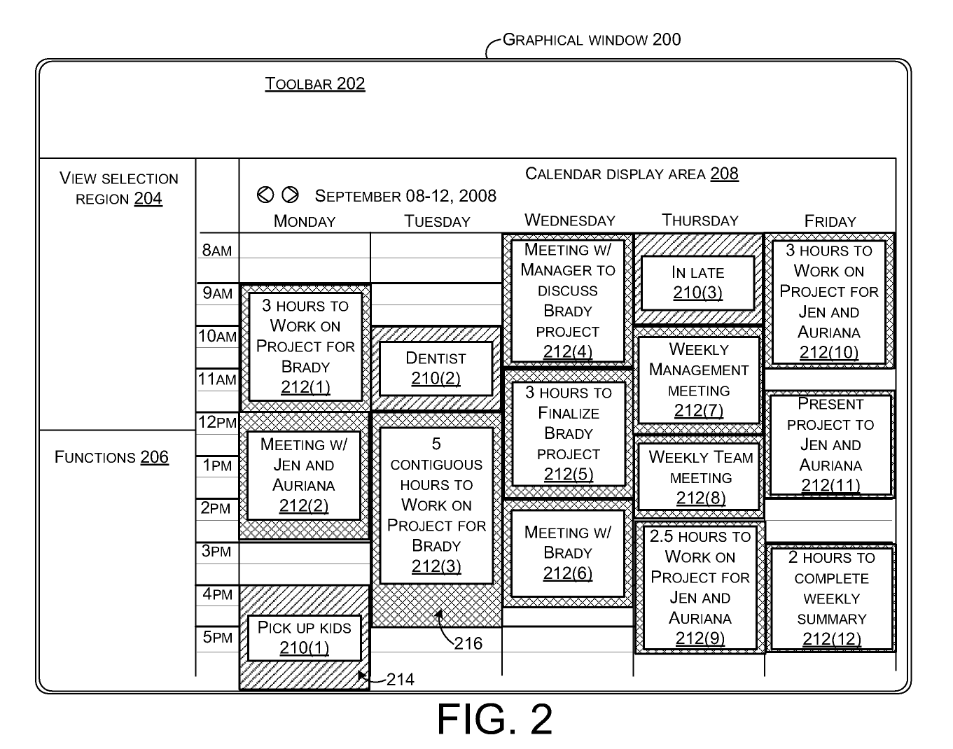

FIGS. 2-8 show exemplary hypothetical screenshots of some implementations of the declarative calendar event scheduling concepts.

FIG. 2 shows a screenshot of a user interface in the form of a graphical window 200 generated by an exemplary declarative calendar application or component. In this case, graphical window 200 includes a toolbar 202, a view selection region 204, a functions region 206 and a calendar display area 208. In this manifestation, calendar display area 208 shows both manually created calendar events 210(1), 210(2), 210(3) and declaratively scheduled calendar events 212(1), 212(2), 212(3), 212(4), 212(5), 212(6), 212(7), and 212(8), 212(9), 212(10), 212(11), and 212(12).

Manually created calendar events 210(1)-210(3) can be presented in a manner that allows them to be distinguished by the user from declaratively scheduled calendar events 212(1)-212(12). In this case, manually created calendar events have a diagonally lined background (indicated at 214), whereas declaratively scheduled calendar events have a cross-hatch pattern (indicated at 216). Other implementations can distinguish between manually created calendar events and declaratively scheduled calendar events utilizing other mechanisms, such as color. Distinguishing manually scheduled calendar events can offer several potential advantages to users of the calendar application as will described in more detail below. Briefly, one potential advantage is that the user, or another user, such as the user's manager can readily identify which calendar events on graphical window 200 are declaratively scheduled.

Accordingly, in some manifestations, the user and/or the manager may be allowed to manually schedule a calendar event over (in conflict with) an existing declaratively scheduled calendar event. In such a case, the calendar application can reschedule the declarative event at another date and time that satisfies the associated constraints. Further, this configuration may provide useful information relating to the ramifications of scheduling calendar events.

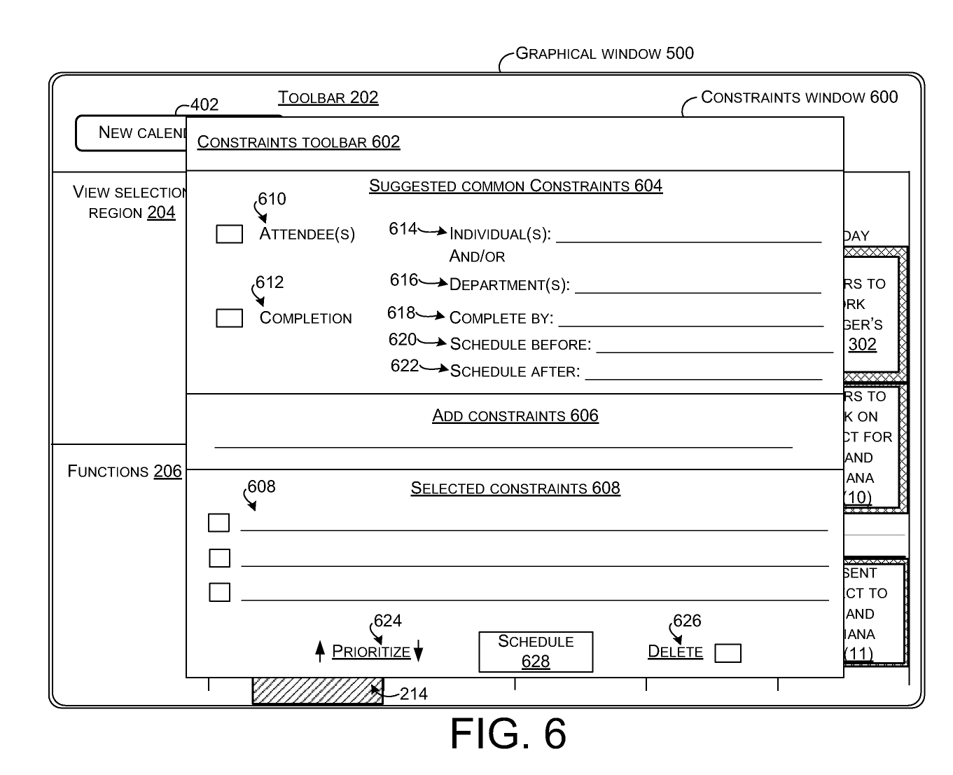

The present implementations offer system users flexibility in how many constraints are selected for a specific declaratively scheduled event. (An example of an interface for selecting constraints is described below in relation to FIG. 6). For example, in the present instance assume that a user specified that he/she needed 8 hours to prepare for the “Meeting with Manager to Discuss Brady Project” 212(4). In this case, the system scheduled the requested calendar event as three hours at 212(1) and five hours as 212(3), both of which occur before meeting 212(4). The illustrated declarative scheduling would also satisfy a situation where the user specified a further constraint that one portion of the 8 hours had to be at least 4 continuous hours. This additional constraint is satisfied by the five hours of 212(3). There can also be multiple ways to define a particular constraint. For instance, in the above example, the user specifies that he/she needs these constraints to be satisfied before this other event (managers meeting 212(4)). Alternatively, the user might specify that within a given time period or time span he/she needs this event to happen. The above example illustrates how a user can assign him/herself a task (i.e., 8 hours to work on Brady Project). The next example can illustrate how one system user can assign tasks for another system user.

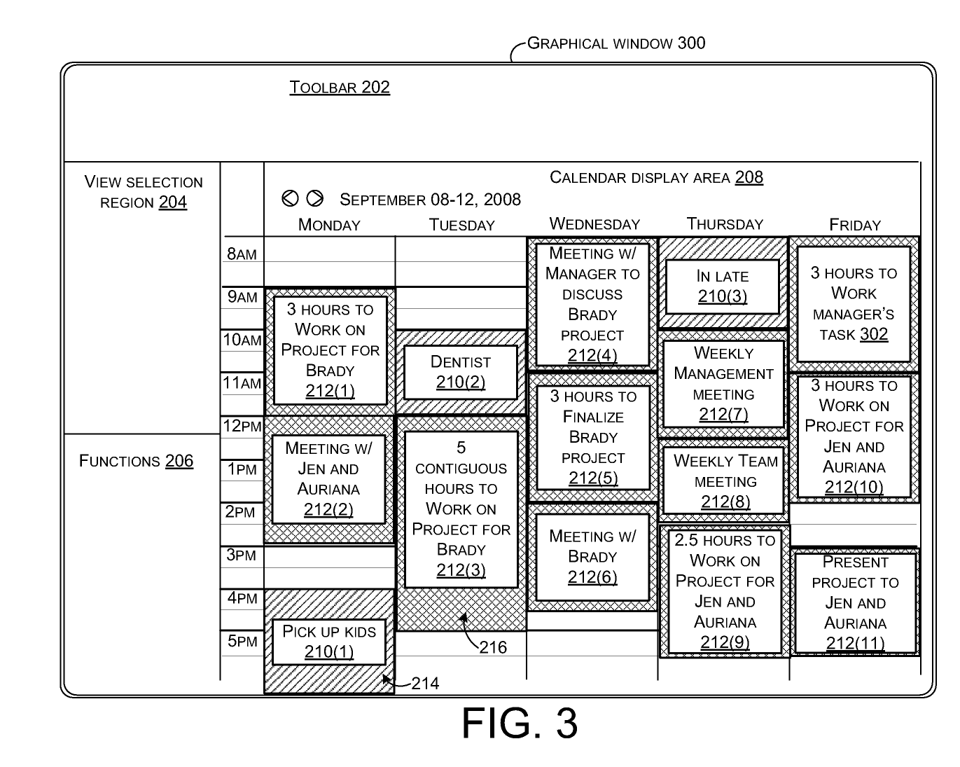

For discussion purposes, assume that the user's manager views graphical window 200 Thursday night at 5:00 P.M. and wants to assign the user a calendar event in the form of a task (hereinafter, “manager's task” specifically designated in FIG. 3). Assume further that the manager assigns three constraints to the manager's task. First, that the task is to be completed by the user. Second, that the task takes three hours. Third, that the task be performed by the end of the workday on Friday.

FIG. 3 shows another graphical window or screenshot 300 that reflects updates to the user's calendar caused by declarative scheduling of the manager's task 302 as defined above. In this case, manager's task 302 is added to the user's calendar for Friday between 8 A.M. and 11 A.M. Calendar event “3 hours to work on project for Jen and Auriana” 212(10) is moved to commence at 11 A.M. Calendar event “present project to Jen and Auriana” 212(11) is moved to 3 P.M. Calendar event “2 hours to complete weekly summary” 212(12) is deleted and rescheduled during the next week (not shown). Accordingly, the user's manager can see the consequences of adding the manager's task to the user's calendar. This information can allow the user's manager to make a more informed decision. For instance, the user's manager will know that the weekly report will be late (and why it is late) if the user's manager goes ahead and schedules the manager's task. Alternatively, the manager may decide that it is not acceptable to push back the weekly report. Accordingly, the user's manager may take other actions such as trying to assign the manager's task to someone else.

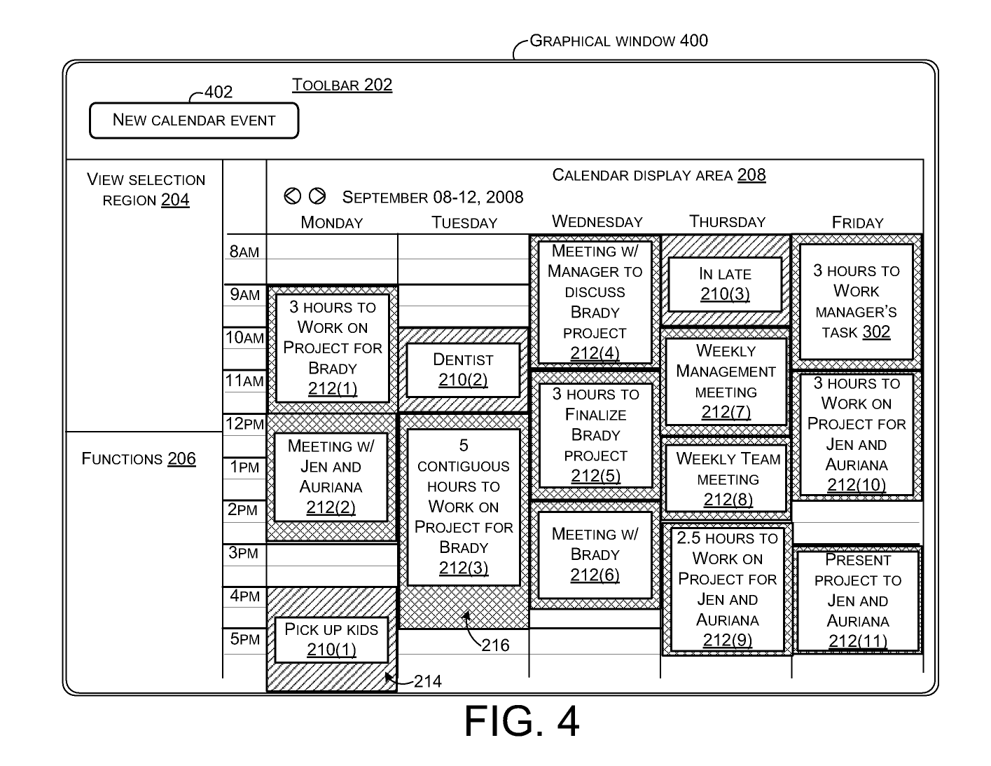

FIG. 4 shows another graphical window 400 that illustrates one implementation for allowing the user to add calendar events. In this case, a “new calendar event button” 402 is designated on toolbar 202. In an instance where the user desires to add a calendar event the user can click on the new calendar event button 402. Various other implementations for allowing the user to add calendar events can allow the user to click on other parts of the tool bar 202 and/or right mouse click over graphical window 400 among others.

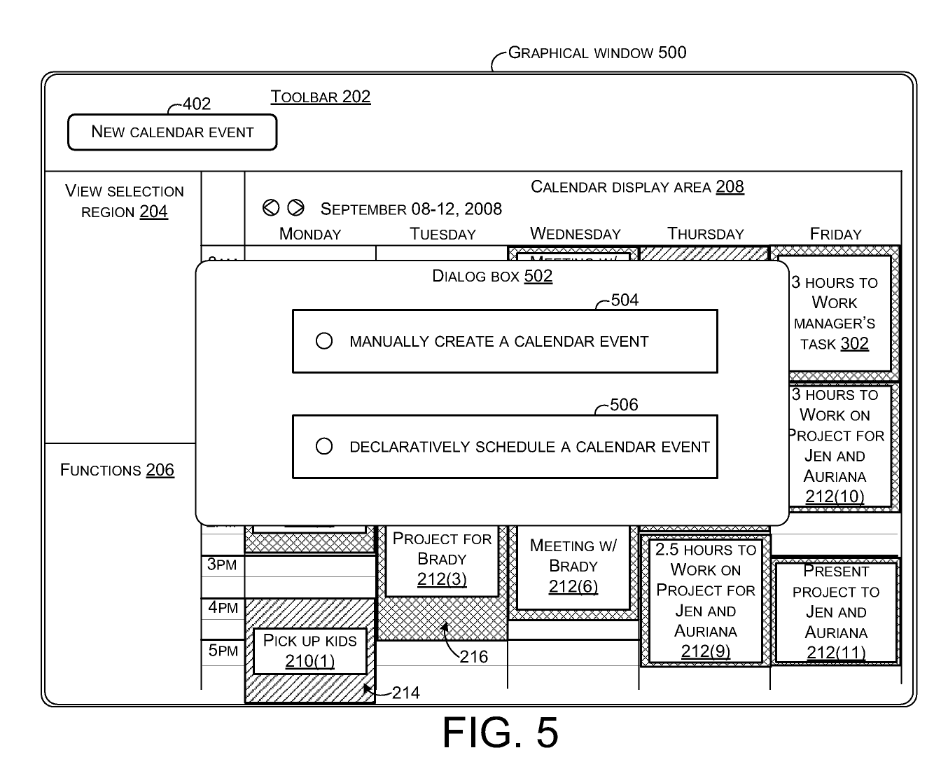

FIG. 5 shows another screenshot of a graphical window 500 that includes a dialog box 502 generated responsively to the user clicking on the new calendar event button 402. Dialog box 502 allows the user to select to “manually create a calendar event” at 504 or to “declaratively schedule a calendar event” at 506. Assume for purposes of example that the user selects to “declaratively schedule a calendar event” at 506. One possible user interface in the form of a constraints window is generated in FIG. 6 responsive to the user selection.

FIG. 6 shows a constraints window 600 superimposed over graphical window 500 responsive to the user selection described above in relation to the discussion of FIG. 5. The constraints window 600 allows the user to specify or otherwise define constraints for the new calendar event. This particular view offers a basic functionality that can be offered via the constraints window 600. A user may select other and/or more advanced constraint selection features via a toolbar 602. Further, while not shown for sake of brevity various dropdown menus or other tools to aid the user in constraint selection can be implemented. In this particular configuration the user is offered an option of selecting from a “suggested common constraints region” 604 and manually defining constraints in an “add constraints” region at 606.

The suggested common constraints region 604 can be offered as a potential time saver to the user and can include a predefined list and/or a list that reflects the user's constraint selections in previous declarative scheduling scenarios (i.e., automatically offer the user his/her previous selections). The add constraints region 606 offers the user the option of manually entering constraints in an instance where the suggested constraints do not apply and/or do not include some or all of the constraints that the user wants to define for the calendar event. Constraints selected by the user from either or both of the suggested common constraints region 604 and the add constraints region 606 can be populated into a selected constraints region 608.

In the illustrated configuration, suggested common constraints region 604 shows two common constraints in the form of attendee(s) 610 and completion 612. The attendee(s) constraint is populated with two options. First, the user can select specific individuals at 614 or by department at 616. For instance, consistent with the earlier discussion, the user may select him/herself, Jen, and Auriana for a calendar event at 614, such as from a drop down menu (not specifically shown). Alternatively, the user may have a new project and specify a representative from the sales department, a representative from the marketing department, and a representative from the creative department under the departments option 616. In the latter scenario, the system that generates the graphical window can access organizational structure information to select the attendees. Usually, the user knows the attendees that he/she desires for a calendar event, but such not need be the case. For instance, the user may simply enter a constraint that someone needs to go to the receptionist's desk everyday between 10:00 and 10:15 so that the receptionist can go on break. The user does not necessarily need to know who is available or what attendee is most appropriate. Though not specifically shown, a dropdown menu of other means for selecting individual and/or department representatives may be provided for the user.

Several options are supplied under the completion constraint 612. For instance, the user can select a complete by date 618 for the calendar event and/or a schedule before some other event(s) 620 and/or schedule after some other event(s) 622. For instance, the user may specify that the calendar event has to be scheduled by the end of the week and after the management meeting.

The add constraints region 606 allows the user the option of manually entering constraints that may not be available in the suggested common constraints section. For instance, the user may specify that they need a certain percent of the specified attendees to be able to attend the calendar event. Such a constraint may be useful in a scenario where the user needs a quorum for voting purposes at the calendar event.

As mentioned above, the user's selected constraints can be auto-populated into the selected constraints region 608 for further consideration. Selected constraints region 608 can allow the user an option of ranking or prioritizing individual selected constraints at 624 and deleting individual selected constraints at 626. Ranking can allow the user to specify the relative importance of individual constraints. Such a feature can be especially useful for scheduling calendar events for lots of attendees and/or for attendees that have very crowded calendars. For instance, the user may specify that the complete by date 618 has highest priority so that at least some type of meeting occurs before a given deadline.

When the user is satisfied with the defined (i.e., selected) constraint(s) the user can click to schedule the calendar event at 628. The calendar event can then be declaratively scheduled for the user based on the selected constraints with reduced, or no, further actions on the part of the user.

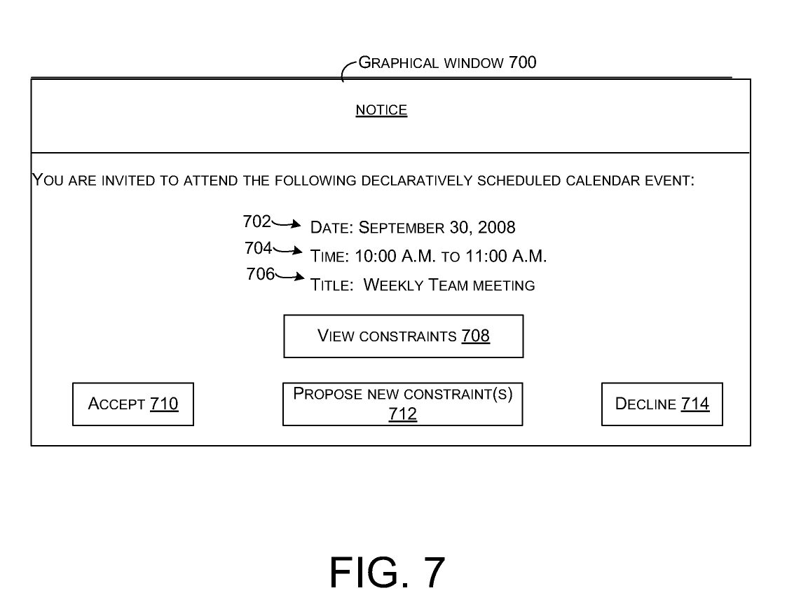

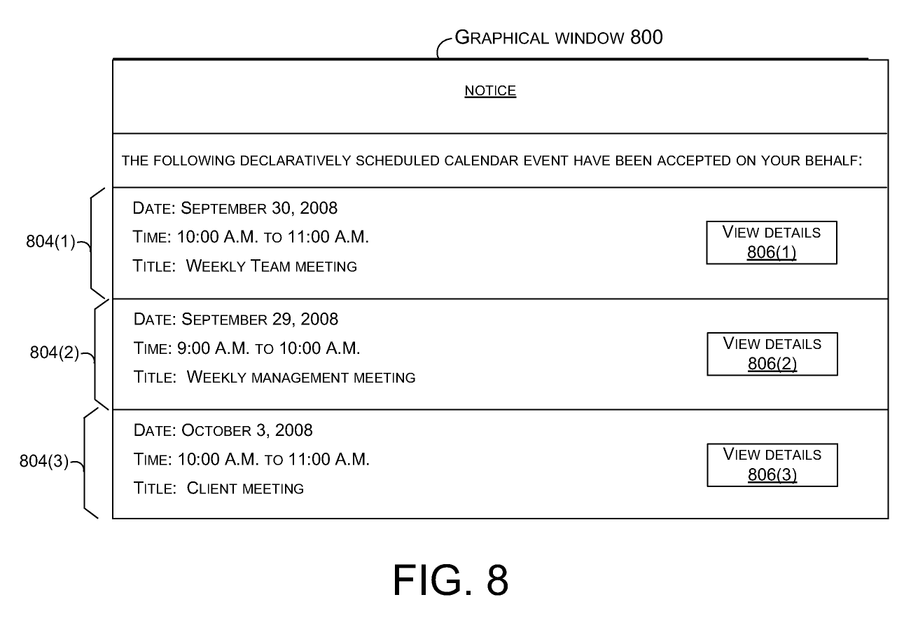

FIGS. 7 and 8 offer two examples of user interfaces that can be generated for an attendee of a declaratively scheduled calendar event.

FIG. 7 involves a graphical window 700 in the form of an email notice sent to a user. The user interface provides some type of notice that the user has been invited to a declaratively scheduled calendar event. The notice can list various aspects relating to the calendar event such as date 702, time 704, and meeting title 706. The user interface may also display constraints associated with the calendar event or offer an opportunity for the user to see the constraints such as via a view constraints feature 708. In this implementation, the user is given three choices in response to the invitation. The user can accept the invitation at 710, propose new constraints at 712, or decline the invitation at 714. Other implementations may not allow the user the option to decline the invitation. Accordingly, either the user accepts the invitation or proposes new constraints. The new constraints can be sent to the original user that requested the declaratively scheduled calendar event for review, or the new constraints can be utilized to automatically declaratively reschedule the calendar event.

In another implementation, the user may define constraints for a proposed calendar event and send the constraints to proposed attendees for review. The proposed attendees can accept or redefine the constraints. Once the constraints are agreed upon, the event can be declaratively scheduled based on the agreed upon constraints.

FIG. 8 offers another user interface 800 that can be generated for invitees of declaratively scheduled calendar events. In this case, the user interface provides a summary of declaratively scheduled calendar events that have been accepted on behalf of the user for a given period. For instance, user-interface 800 could be generated once a day for the user to show the declaratively scheduled calendar events that have been accepted on behalf of the user in the previous 24 hours. Here, three declaratively scheduled calendar events 804(1), 804(2), and 804(3) are shown. User interface 800 can also offer the user an opportunity to see more details about a particular event as can be evidenced at 806(1), 806(2), and 806(3), respectively. The details may be provided on another user interface that can also allow the user to over-ride the acceptance, such as by proposing additional constraints.

In some implementations, the user may predefine how he/she wants declaratively scheduled calendar events to be presented. For instance, the user could select from the configuration presented in relation to FIG. 7 or the configuration presented in relation to FIG. 8, among others. The user can predefine the presentation utilizing various configuration settings that can be presented on one or more of the declarative calendar interfaces.

### Exemplary Operating Environments

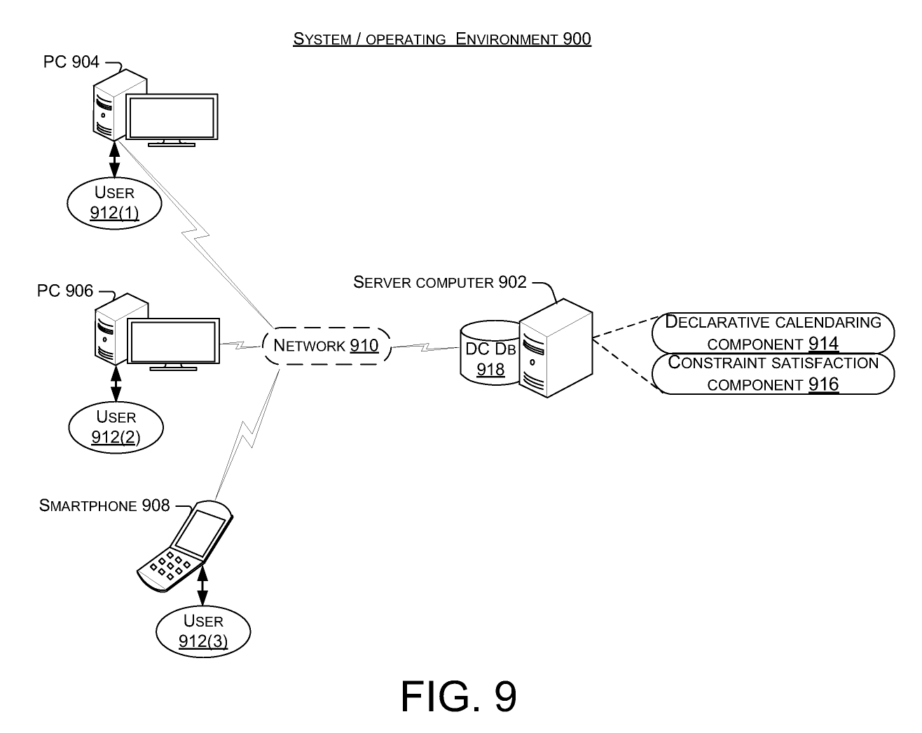

FIG. 9 shows an exemplary operating environment 900 in which declarative event calendar concepts described above and below can be implemented on various computing devices. In this case, the computing devices are manifested as a server computer 902, two personal computers (PCs) 904, 906 a smart phone 908. The computing devices 902-908 can be communicably coupled with one another via a network 910, such as the Internet or another communication mechanism. Computing devices 904-908 can generate interfaces (examples described above) through which users 912(1), 912(2), and 912(3), respectively, can utilize the present declarative event calendar concepts.

In this manifestation, server computer 902 includes a declarative calendar component 914, a constraint satisfaction component 916, and a storage component in the form of a declarative calendar database 918. The declarative calendar component 914, constraint satisfaction component 916, and declarative calendar database 918 can operate cooperatively to create declarative calendar user interfaces such as those described above in relation to FIGS. 2-8. For instance, the declarative calendar database 918 can store any kind of data that can be useful for declarative scheduling. For example, the declarative calendar database 918 can store data associated with individual users (in this case users 912(1)-912(3) for generating their calendars. Further, the declarative calendar database 918 can store constraints (and their relative priorities) associated with specific declaratively scheduled calendar events and/or commonly used constraints. Further still, the declarative calendar database can store information relevant to declarative calendar event scheduling, such as geographic distances between buildings, offices, conference rooms, traffic flows, etc.

Declarative calendar component 914 can generate user interfaces related to declarative event calendars and/or calendaring. The declarative calendar component can obtain constraints from a user and/or declarative calendar database 918 and send the constraints to constraint satisfaction component 916. The constraint satisfaction component can operate on these constraints to declaratively schedule calendar events. This information is returned to the declarative calendar component 914 which can cause appropriate interfaces to be generated on computers 904-908 for the respective users 912(1)-912(3).

The configuration of system 900 can be termed a distributed or centralized configuration in the declarative calendar component 914, constraint satisfaction component 916 and declarative calendar database 918 that contribute to accomplishing declarative calendar event scheduling are located on the server computer 902. In other configurations, some or all of these components 914-918 may alternatively or additionally be manifest on one or more of computing devices 904-908.

In the present discussion, smart phone 908 can be representative of any number of ever evolving classes of computing devices that can offer one or more of the following: cellular service, internet service, and some processing capabilities combined with a human interface such as a graphical interface. Other current examples of this class can include personal digital assistants and cell phones, among others. Similarly, PCs 904-906 can alternatively be manifest as Apple brand computers, Linux based computers, thin clients, and set-top boxes, among others.

### Exemplary Methods

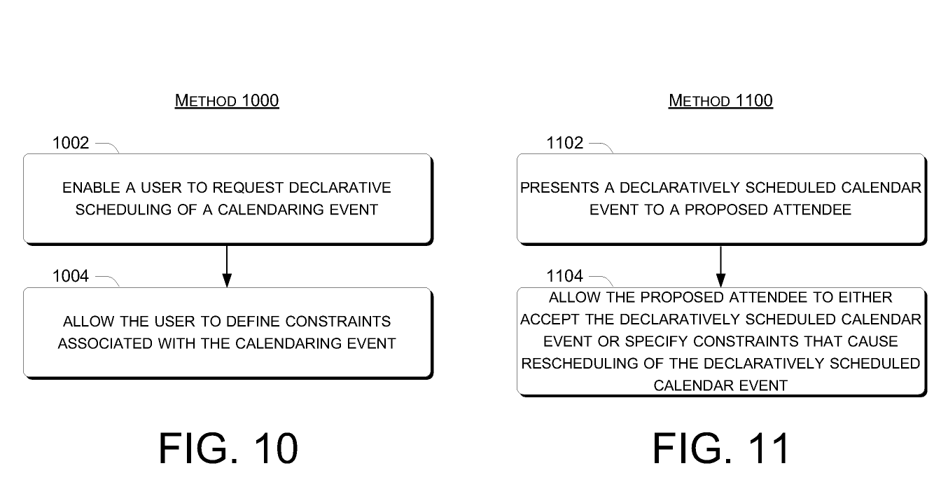

FIG. 10 illustrates a flowchart of a method or technique 1000 that is consistent with at least some implementations of the present concepts. The order in which the technique 1000 is described is not intended to be construed as a limitation, and any number of the described blocks can be combined in any order to implement the technique, or an alternate technique. Furthermore, the technique can be implemented in any suitable hardware, software, firmware, or combination thereof such that a computing device can implement the technique. In one case, the technique is stored on a computer-readable storage media as a set of instructions such that execution by a computing device causes the computing device to perform the technique.

Block 1002 enables a user to request declarative scheduling of a calendar event. In some configurations, declarative scheduling may be the sole option provided to the user. In other configurations, the user may be able to select between traditional scheduling (i.e., the user selects the date and time) and declarative scheduling. A non-limiting example of a user interface for accomplishing block 1002 is described above in relation to FIG. 5. The skilled artisan should recognize many other implementations for accomplishing block 1002.

Block 1004 allows the user to define constraints associated with the calendar event. Non-limiting examples of constraints that may be defined in relation to block 1004 are described in the discussion above relating to FIGS. 2-8. A non-limiting example of a user interface for accomplishing block 1004 is described above in relation to FIG. 6. In that particular example, commonly used constraints are suggested for the user. The user can select any of the suggested constraints and/or define his/her own constraints. The skilled artisan should recognize many other implementations for accomplishing block 1004. Further, the skilled artisan should recognize that a potentially infinite number of constraints can be envisioned that could be applied in particular declarative scheduling scenarios. It is worth noting that the date and time of the event can even be used as constraints. For instance, a user may specify constraints for a meeting and one of those constraints could be the user would prefer the meeting be declaratively scheduled for Wednesday morning at 9:00 A.M. if that time satisfies the other constraints.

FIG. 11 illustrates a flowchart of a method or technique 1100 that is consistent with at least some implementations of the present concepts. The order in which the technique 1100 is described is not intended to be construed as a limitation, and any number of the described blocks can be combined in any order to implement the technique, or an alternate technique. Furthermore, the technique can be implemented in any suitable hardware, software, firmware, or combination thereof such that a computing device can implement the technique. In one case, the technique is stored on a computer-readable storage media as a set of instructions such that execution by a computing device causes the computing device to perform the technique.

Block 1102 presents a declaratively scheduled calendar event to a proposed attendee. Two non-limiting examples of user interfaces for accomplishing block 1102 are described above in relation to FIGS. 7-8. The skilled artisan should recognize many other implementations for accomplishing block 1102.

Block 1104 allows the proposed attendee to either accept the declaratively scheduled calendar event or specify constraints that cause rescheduling of the declaratively scheduled calendar event. Causing the proposed attendee to specify additional scheduling constraints if he/she does not want to accept can provide a basis for rescheduling the proposed declaratively scheduled calendar event. Other configurations can allow a proposed attendee to decline an invitation without specifying additional constraints. However, such a configuration may have a higher likelihood that the subsequent invitation will also be declined since the system lacks constraint information (i.e., why was the proposed event declined) from which to reschedule.

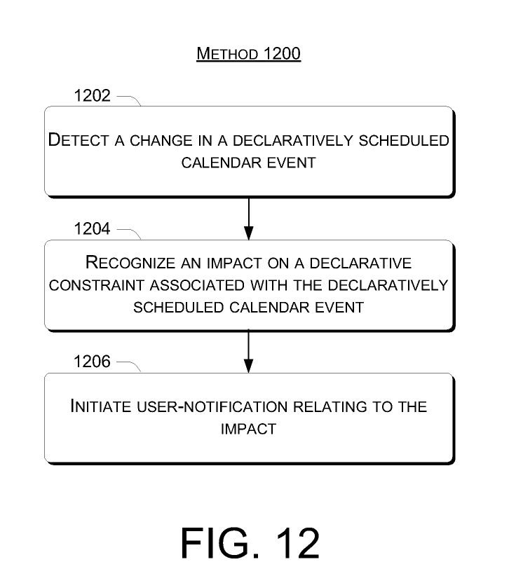

FIG. 12 illustrates a flowchart of a method or technique 1200 that is consistent with at least some implementations of the present concepts. The order in which the technique 1200 is described is not intended to be construed as a limitation, and any number of the described blocks can be combined in any order to implement the technique, or an alternate technique. Furthermore, the technique can be implemented in any suitable hardware, software, firmware, or combination thereof such that a computing device can implement the technique. In one case, the technique is stored on a computer-readable storage media as a set of instructions such that execution by a computing device causes the computing device to perform the technique.

Block 1202 detects a change in a declaratively scheduled calendar event. For instance, a user may want to manually, or via declarative scheduling, change the calendar event. For example, an attendee may not be able to attend a declaratively scheduled meeting or a manager may want to assign another task to a user that has a higher priority than the declaratively scheduled calendar event.

Block 1204 recognizes an impact on a declarative constraint associated with the declaratively scheduled calendar event. For instance, say the declarative constraint is that all managers have to be present and unanimously give final approval of a product before a ship date. If at block 1202 one of the managers cancels attendance to the manager's meeting, then at block 1204 the technique may recognize that the constraint of getting the product shipped on the ship date may be affected by the cancellation.

The technique can initiate user-notification relating to the impact at block 1206. The notification may be made at the time of the proposed cancellation (i.e., before the user selects to either approve or cancel a proposed change). So for instance, when a user selects that he/she wants to cancel the meeting (or his/her attendance) a notice may appear of the impact so that the user can select to go ahead and make the change or cancel the change. For example, this notice may be manifest as a user-interface that specifies the proposed change (e.g., cancelling the meeting) and lists the impacts of the change. The user-interface can include buttons from which the user can either expressly make the change or cancel the change. In either case information regarding the impact is provided so that user can make an informed decision.

The user-notification may be provided to one or more of, the user attempting to make the change and users tied to the constraint, among others. So, for instance, the user-notification may be provided to all managers who are responsible for meeting the ship date and/or a director who established the ship date as a declarative constraint. This feature can allow relevant participants and/or users to see the impact of any changes made to the declarative calendar system.

The user-notification may be manifested differently for different involved (i.e., tied) users. For instance, as mentioned above, a user-interface generated for the user actually initiating the change may have a different appearance than the user-notification provided to other involved users.

The present concepts can allow users to more easily schedule calendar events. For instance, the user simply defines one or more constraints relating to the calendar event and it can be automatically declaratively scheduled on the user's behalf without further effort. The concepts can also offer information to users about potential ramifications of scheduling calendar events. For instance, scheduling a new project with a high priority may cause another project to be delayed. The user can then decide whether to go ahead and schedule the new calendar event, change its constraints, or cancel it based upon this information.

Many of the examples described above relate to a business context. Other business examples may allow some or all of the complex manual scheduling now performed by an operation manager to be automatically completed via declarative scheduling. Further, declarative scheduling could improve employee morale. For instance, when dealing with multiple employees, operation managers often become frustrated with employee scheduling requests and as a result disregard them all. With declarative scheduling, the operation manger can enter that “employee A prefers not to work Fridays” and “employee B prefers to work afternoons” as constraints. These constraints may be assigned a low priority, but the declarative event scheduling system will automatically satisfy them if possible.

The present concepts also lend themselves to social settings. For instance, say a user wants to keep in touch with friends. The declarative scheduling system might offer a constraint such as “keep in touch by having lunch” with my friends at least one time per quarter. Then these lunches automatically get scheduled via declarative scheduling.

### CONCLUSION

Although techniques, methods, devices, systems, etc., pertaining to declarative scheduling scenarios are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A system, comprising:
a storage component configured to store scheduling constraints relating to at least one user; and,
a declarative calendar component configured to automatically schedule declarative calendar events for the at least one user based upon the scheduling constraints.

2. The system of claim 1, wherein the at least one user comprises multiple users and wherein the storage component comprises a centralized database that is configured to store the scheduling constraints of individual users.

3. The system of claim 1, wherein the declarative calendar component is configured to cause declarative calendar events to be presented on a user interface in a different form than manually-created calendar events.

4. The system of claim 1, wherein the declarative scheduled calendar events can cover a time span and include multiple portions with the time span.

5. The system of claim 1, wherein the declarative calendar component is configured to cause declarative calendar events to be presented on a user interface in a different form than manually-created calendar events and is further configured to reschedule an individual declarative calendar event in an instance where a user manually schedules a calendar event that conflicts with the individual declarative calendar event.

6. The system of claim 5, wherein the user interface allows a first user to view a second user's calendar.

7. The system of claim 1, wherein the declarative calendar component is configured to cause declarative calendar events to be presented on a user interface in a different form than other calendar events and is configured to reschedule the declarative calendar events in an instance where the user schedules an individual other calendar event in conflict with an individual declarative calendar event.

8. The system of claim 1, wherein the storage component is configured to store the scheduling constraints and associated user assigned priorities for individual scheduling constraints.

9. The system of claim 1, wherein the declarative calendar component comprises a constraint satisfaction component.

10. The system of claim 1, wherein the declarative scheduling component is also configured to allow the at least one user an option of manually scheduling calendar events and wherein manually scheduled calendar events are displayed in a different color from declarative calendar events.

11. A method, comprising:
presenting a declaratively scheduled calendar event to a proposed attendee; and,
allowing the proposed attendee to either accept the declaratively scheduled calendar event or specify constraints that cause rescheduling of the declaratively scheduled calendar event.

12. The method of claim 11, wherein the allowing comprises allowing the proposed attendee to pre-configure settings so that the declaratively scheduled calendar event is automatically accepted unless there is a conflict on the proposed attendee's calendar.

13. The method of claim 11, wherein the presenting comprises presenting a cumulative view of all calendar changes made on behalf of the proposed attendee through declarative scheduling for a given period.

14. The method of claim 11, wherein the presenting and the allowing are accomplished via a single graphical window of a user interface.

15. A computer-readable storage media having instructions stored thereon that when executed by a computing device cause the computing device to perform acts, comprising:
enabling a user to request declarative scheduling of a calendar event; and,
allowing the user to define constraints associated with the calendar event.

16. The computer-readable storage media of claim 15, wherein the enabling comprises generating a calendar user-interface that allows the user to select from one of: manually scheduling the calendar event and requesting declarative scheduling of the calendar event.

17. The computer-readable storage media of claim 15, wherein the allowing comprises one or more of: providing a list of potential constraints and allowing the user to select constraints from the list for the calendar event, and allowing the user to manually enter the defined constraints.

18. The computer-readable storage media of claim 15, wherein the allowing comprises allowing the user to assign a relative priority rank to the defined constraints.

19. The computer-readable storage media of claim 15, further comprising:
detecting a change to another declaratively scheduled calendar event produced by the declarative scheduling;
recognizing an impact on a different declarative constraint associated with the another declaratively scheduled calendar event; and,
initiating user-notification relating to the impact.

20. The computer-readable storage media of claim 15, further comprising:
facilitating the user sending the constraints to a different user that can redefine the constraints; and,
declaratively scheduling a calendar event based at least in part on the defined constraints.
